(19) United States
(12) Patent Application Publication
(10) Pub. No.: US 2009/0272593 A1
(43) Pub. Date: Nov. 5, 2009

(54) Motorcycle Frame Arrangement

(76) Inventors: Christopher Myers, Miami Beach, FL (US); Shawn Robert Brown, Gray, PA (US)

Correspondence Address: Christopher Myers, P.O. Box 610910, Miami, FL, 33261, US

(21) Appl. No.: 12/111,965

(22) Filed: Apr. 30, 2008

(51) Int. Cl. B62D 61/02

(52) U.S. Cl. 180/219

(57) ABSTRACT

A motorcycle frame arrangement formed of a main frame including a top head and a downwardly extending support bar, a down tube connected with the top head and extending rearwardly and downwardly therefrom, a lower frame secured to the bottom of the down tube and a sub-frame releasably connected with the support bar and the lower frame and carrying a motor for driving the motorcycle.

### BACKGROUND OF THE INVENTION

1. Field of the Invention

The present invention relates to a motorcycle frame arrangement utilizing a sub-frame forming part of a motor/engine cassette to facilitate access to the engine for quick repair, inspection or analysis and quick removal and replacement of the engine.

2. Discussion of the Prior Art

Motorcycle frame arrangements in the past have utilized perimeter frames but have the disadvantage of mounting motors/engines in a manner not facilitating repair, inspection or replacement.

### SUMMARY OF THE INVENTION

The motorcycle frame arrangement utilizes a down tube having a cross-sectional configuration throughout its length so as to be uniform throughout its length with the configuration having equally angled sides thereby providing reinforcement of the connection of the down tube with the lower frame which also provides increased efficiency in production automation while assuring a correct fit prior to assembly of parts.

The design of the down tube and connection to the lower frame allows frame forces to be transferred without placing loads on the sub-frame such that the sub-frame can be removed along with the engine to be disconnected for quick removal of the engine without impacting the support of the frame.

The configuration of the down tube and the connection of the down tube to the lower frame allows frame forces to be transferred without placing loads on the sub-frame, thus permitting the sub-frame to be removed and the engine to be loosened whereby the engine can drop downward and hang for quick repair, inspection or analysis.

The motorcycle frame arrangement includes a sub-frame forming part of a motor/engine cassette, the sub-frame being mounted to a main frame of the motorcycle by bolts or other pivotal hardware to facilitate access to the engine for quick repair, inspection or analysis. The engine can be easily removed and replaced without impacting frame support by removing and/or loosening the bolts.

Inasmuch as the present invention is subject to many variations, modifications and changes in detail, it is intended that all subject matter discussed above or shown in the accompanying drawings be interpreted as illustrative only and now be taken in a limiting sense.

### BRIEF DESCRIPTION OF THE DRAWINGS

FIG. 1 is a perspective view of the motorcycle frame arrangement.

FIG. 2 is a side view of the motorcycle frame arrangement.

FIG. 3 is a bottom perspective of the motorcycle frame arrangement without the sub-frame.

FIG. 4 is a broken perspective, with dashed lines, of the bottom of the down tube and lower frame of the motorcycle frame arrangement.

FIG. 5 is a top perspective of the motorcycle frame arrangement without the sub-frame.

FIG. 6 is a broken perspective of the motorcycle frame arrangement with a motor/engine mounted therein.

FIG. 7 is a side view of a motorcycle including the frame arrangement.

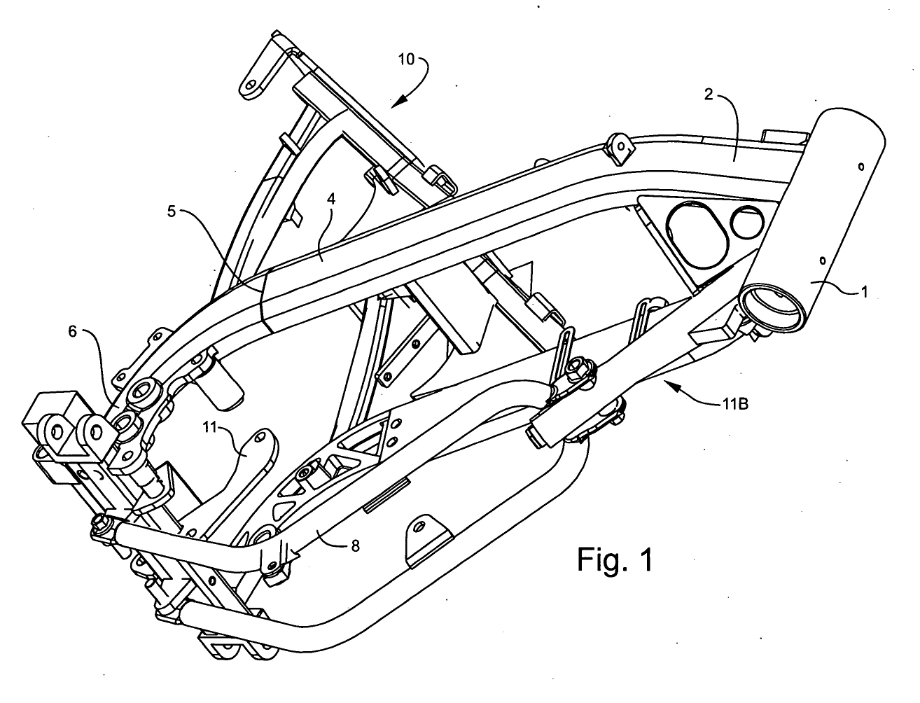

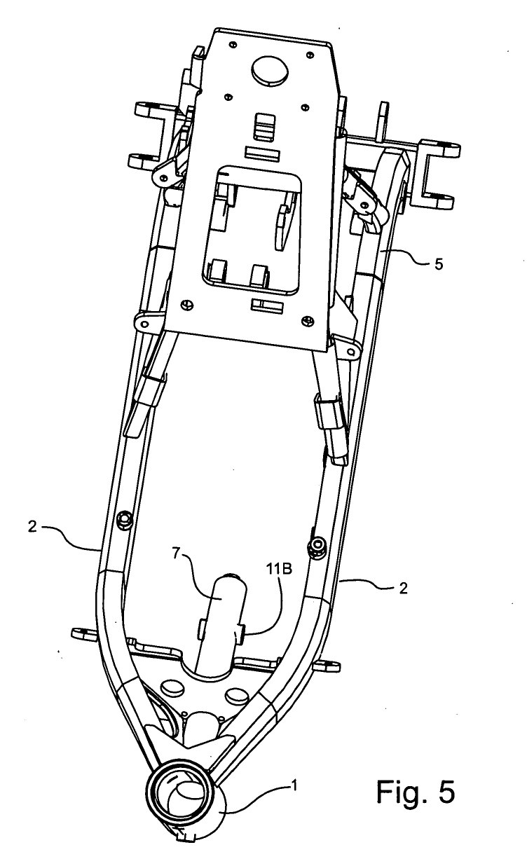

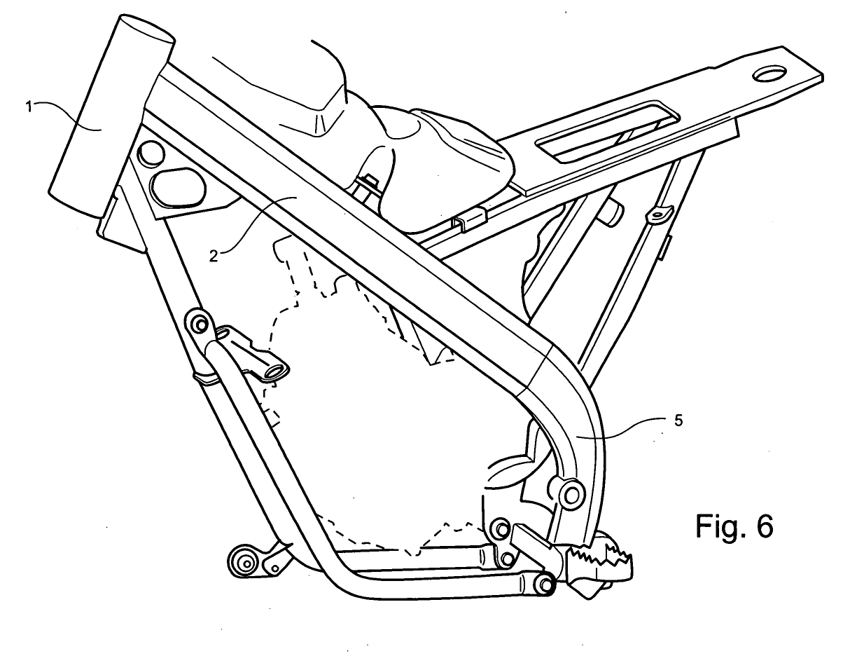

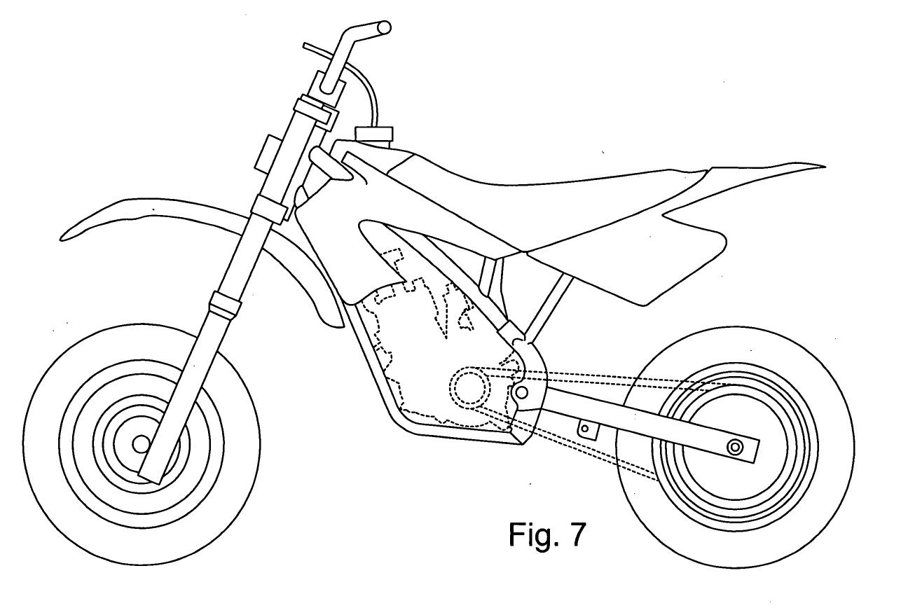

FIGS. 1C, 2C, 3C, 4C, 5C, 6C and 7C are color renditions of FIGS. 1, 2, 3, 4, 5, 6 and 7, respectively, for clarification purposes.

### DESCRIPTION OF THE PREFERRED EMBODIMENTS

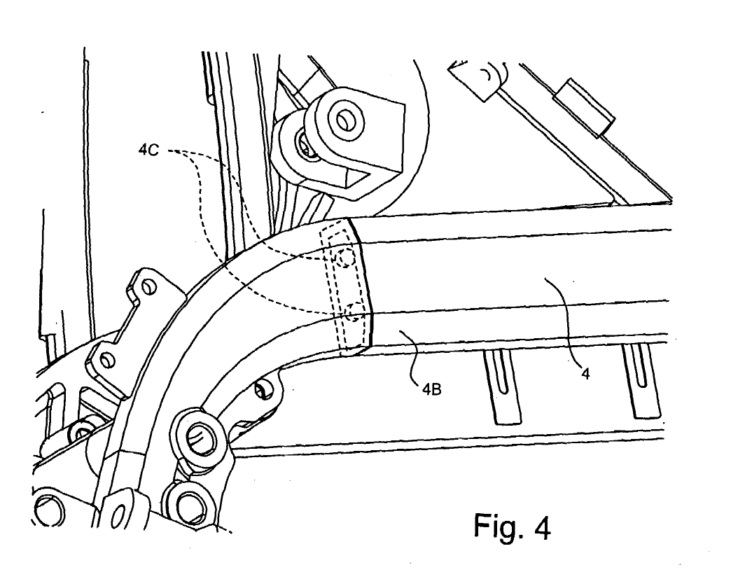

As shown in FIGS. 1, 2, 3, 4, 5, 6 and 7 and 1C, 2C, 3C, 4C, 5C, 6C and 7C, the motorcycle frame arrangement includes a main frame extending from a top head 1 rearwardly to angled portions 9 and 10 and a down tube 2 extending rearwardly and downwardly from top head 1 to be connected or secured to a lower frame 5 as shown at 4c in FIG. 4 and 4 in FIG. 1. Strengthening support wedges 3 are disposed between top head 1 and down tubes 2. The top head is constructed of forged aluminum. The bottom or lower portion of the top head is connected with wedged reinforcements to a hollow sub-frame support bar 7. As shown, the sub-frame support bar is round in nature and, preferably, has an internal rib, not shown, providing additional structural support.

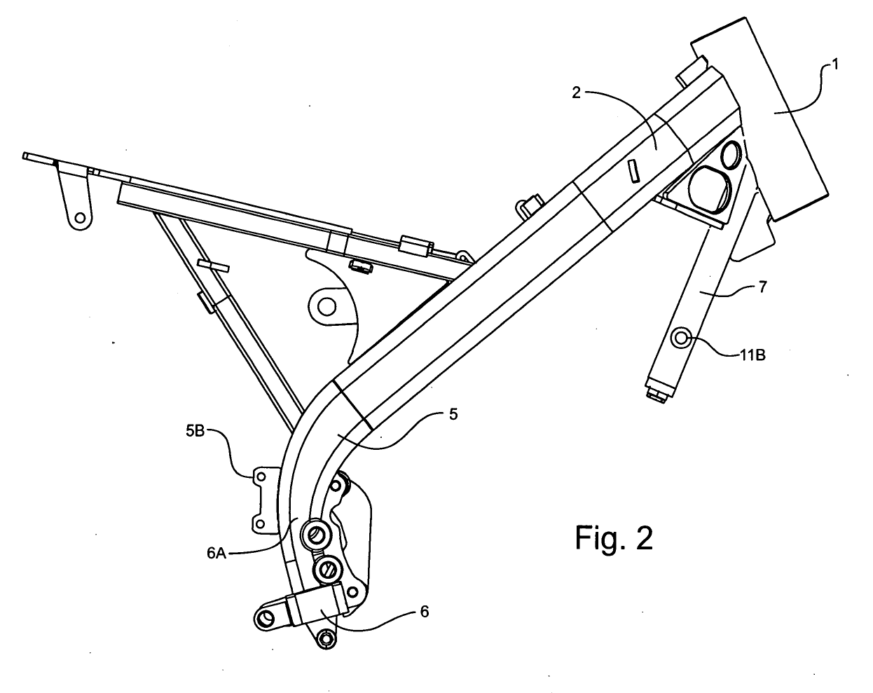

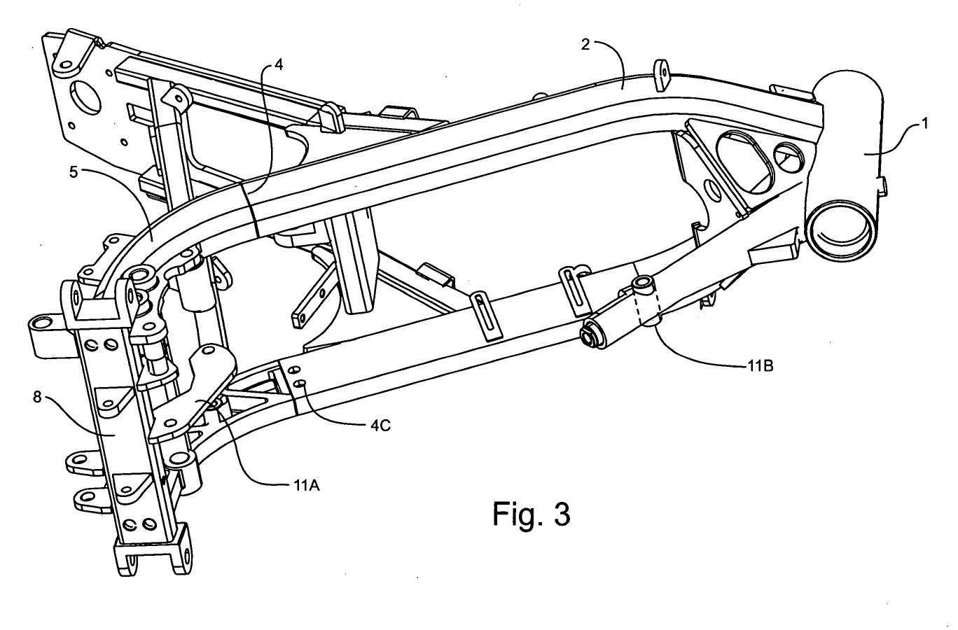

The down tubes 2 are preferably constructed of forged aluminum or steel and are connected to a lower frame 5 by welding. As best shown in FIG. 4, the down tube has angled edges 4b on each side with the angles being symmetric in length and position and has a flat side surface 4a. The down tube can the reinforced with an internal rib, if desired. The lower frame 5 is connected and welded to the down tube at 4, as noted above, and carries spaced apertured ears or lugs 8a on the bottom thereof for connection with the ends of parallel spars of a sub-frame 8 which is mounted on the sub-frame support bar via a bolt or other pivotal connector at 11b shown in FIG. 3. The lower frame 5 is welded to the bottom ends of the down tubes 2 and, essentially, has a U-shape with lugs 8a extending downwardly from the bottom of the lower frame to mount the sub-frame B. As shown in FIG. 2, the rear swing arm is mounted to the lower frame at 5a using a swing arm bolt and bushing in the lower frame for fitness and correctness. Foot pegs P for the motorcycle are mounted to the lower frame at 5c, and the rear brake master cylinder is mounted at 6. The sub-frame 8 forms part of a motor/engine cassette and is bolted to the apertured lugs as shown in FIG. 8 and to the sub-frame support bar at 11b. 11a is connected with the motor/engine cassette to permit proper mounting relative to the sprocket drive with the motorcycle.

The sub-frame 8 is releasably mounted to the motorcycle frame and disconnects 8 from the sub-frame support bar and the lower frame such that the engine can be disconnected from 11b and loosened at 11a. This, combined with the removal of the sub-frame 8, allows the engine to swing downward. Complete disconnection of the engine at 11a and 11b allows the entire engine to be removed downward and to the side for quick removal and/or replacement.

It will be appreciated from the above that the motorcycle frame arrangement is formed of a main frame, a lower frame and a sub-frame carrying a motor/engine for during the motorcycle with the sub-frame being releasably connected with the main frame and the lower frame in a manner to permit the sub-frame to be either pivoted or removed to provide quick access to the motor/engine for repair, inspection, analysis and/or replacement.

Inasmuch as the present invention is subject to many variations, modifications and changes in detail, it is intended that all subject matter discussed above or shown in the accompanying drawings be interpreted as illustrative only and not be taken in a limiting sense.

What is claimed is:

1. A motorcycle frame arrangement comprising
a main frame including a top head and a downwardly extending support bar;
down tubes connected with the top head and extending rearwardly and downwardly therefrom;
a lower frame connected with the bottoms of the down tubes; and
a sub-frame releasably connected at a front portion with the support bar and at a rear portion with the lower frame, the sub-frame carrying a motor for driving the motorcycle.

2. A motorcycle frame as recited in claim 1 wherein the sub-frame forms part of a motor cassette that can be accessed by movement of the sub-frame.

3. A motorcycle frame as recited in claim 2 wherein the sub-frame is formed of spaced spars bolted to the lower frame and the support bar.
